(19) United States
(12) Patent Application Publication
(10) Pub. No.: US 2024/0194367 A1
(43) Pub. Date: Jun. 13, 2024

(54) Device and Method for Generating Optical Tweezers

(71) Applicants: Universität Stuttgart, Stuttgart (DE); Fraunhofer-Gesellschaft zur Förderung der angewandten Forschung e.V., München (DE)

(72) Inventors: Florian MEINERT, Stuttgart (DE); Philipp ILZHOEFER, Stuttgart (DE); Tilman PFAU, Stuttgart (DE); Martin TRAUB, Aachen (DE); Martin ADAMS, Aachen (DE); Hans-Dieter HOFFMANN, Aachen (DE)

(73) Assignees: Universität Stuttgart, Stuttgart (DE); Fraunhofer-Gesellschaft zur Förderung der angewandten Forschung e.V., München (DE)

(21) Appl. No.: 18/530,288

(22) Filed: Dec. 6, 2023

(30) Foreign Application Priority Data
Dec. 6, 2022 (EP) 22211813.5

(51) Int. Cl. G21K 1/00; G21K 1/06

(52) U.S. Cl. CPC G21K 1/003; G21K 1/06; G21K 2201/067

(57) ABSTRACT

The present invention relates to a device (10) for generating optical tweezers comprising a laser beam source (11) for generating a laser beam (12) and at least one acousto-optic deflector (13) for generating an array (15) of partial beams (14) of the laser beam (12), wherein the array (15) comprises rows (15c). The device (10) further comprises a stepped mirror unit (16) comprising at least a first stepped mirror (25) for reducing a row distance (15d) of the partial beams (14) of the array (15), wherein the first stepped mirror (25) comprises mirrors (30), a stepped distance (25a) between adjacent mirrors (30) and a stepped height (25b).

The present invention relates to a device and a method for generating optical tweezers.

### PRIOR ART

Devices for generating optical tweezers, which are used, for example, for trapping atoms for quantum computers, are generally known from the prior art. For example, US 2020/0185120 A1 describes a method for rearranging atoms in arrays, wherein the atoms are in the Rydberg quantum state. Furthermore, due to the arrangement of the acousto-optic deflectors used, the sliding movements of the atoms are highly correlated, which severely restricts individual dynamic position control in the array. This is particularly due to the fact that when two acousto-optic deflectors are connected in series at an angle, the row generated by the first acousto-optic deflector is copied several times with the second acousto-optic deflector to generate a 2D array. This means that shift operations cannot be performed for individual rows.

The object of the present invention is to further develop a device for generating optical tweezers, preferably for trapping atoms for a quantum computer, as well as a corresponding method in such a way that the positions as well as the amplitudes of the optical tweezers can be adjusted dynamically and with microsecond accuracy, while further realizing an optical tweezer array with the largest possible fill factor.

### Description of the Invention: Task, Solution, Advantages

The aforementioned task is solved by a device for generating optical tweezers, which comprises a laser beam source for generating a laser beam. Furthermore, the device comprises at least one acousto-optic deflector for generating an array of partial beams of the laser beam and a stepped mirror unit comprising at least one first stepped mirror for reducing a distance between the partial beams of the array in at least one first direction. The laser beam source is in particular a high-power laser. In particular, a high-power laser has a CW power of 10 to 100 watts. In particular, the device is used for trapping atoms for a quantum computer by means of the optical tweezers that form optical traps.

The at least one acousto-optic deflector is used to generate an array of partial beams of the laser beam, wherein the array comprises rows. An array is thus preferably understood to be an arrangement in two dimensions. The partial beams are preferably aligned parallel to each other. In particular, the array is a 2D array. Adjacent rows can have a preferably constant row distance. The partial beams form optical traps, particularly at the location of the atoms to be captured. For this purpose, the partial beams are primarily focused.

The rows of the array are preferably spaced in a first direction, while rows extend in a second direction. The first and second directions are preferably not fixed, but are defined in relation to the array. These are relative directions. This means that the directions can change in absolute terms after a reflection of the array. The partial beams propagate in a third direction, which is perpendicular to the first and second directions. The distance of the partial beams in the first direction is therefore preferably understood as the row distance. The partial beams can form gaps in the second direction. Alternatively, the partial beams can be unevenly distributed within different rows so that no gaps are formed. If gaps are formed, the distance of the partial beams in the second direction represents the gap distance. The distance of adjacent partial beams within a row or the gap distance can differ from the row distance. Further, they can be the same size. In particular, a row and/or a column of the array comprises more than 10, preferably more than 15, most preferably more than 18, partial beams.

The device comprises a stepped mirror unit comprising at least a first stepped mirror. The stepped mirror unit is used for reducing a row distance of the partial beams of the array.

A stepped mirror comprises a plurality of mirrors that are arranged offset to each other in two directions. Preferably, a stepped mirror comprises more than 5, preferably more than 7, most preferably more than 9 mirrors. In particular, all mirrors of a stepped mirror have a parallel alignment. Advantageously, all mirrors are arranged at an angle of 45° to the incoming light and thus also 45° to the decoupled light.

A stepped mirror comprises a stepped distance between adjacent mirrors and a stepped height The stepped height can also be understood as the mirror height.

In particular, adjacent mirrors are arranged offset from one another by a stepped distance in the first direction and by a stepped height in a direction perpendicular to the first direction. Adjacent mirrors are preferably offset by the stepped distance in the first direction. The offset by a stepped height occurs in particular in the propagation direction of the partial beams. The directions specified in relation to optical units, such as stepped mirrors, refer to the incoming array, i.e. to the array before a reflection.

Due to the offset of the mirrors steps are created, which give the stepped mirror its name. Above all, the mirrors have a minimum width perpendicular to the stepped height and the stepped distance, which corresponds to the width of the array in the second direction at the location of the stepped mirror.

The mirrors can be arranged separately. In other words, they can be individually adjustable. Furthermore, the mirrors can be formed as surfaces of a common component. This means that only one adjustment of the common component is necessary.

By using the stepped mirror unit, the row distance of the array can be significantly reduced, so that the fill factor of the array is particularly high. The fill factor in particular is to be understood as the ratio of the 1/e² diameter number of the partial beams and thus the tweezers per unit area. In other words, atoms captured by the tweezers are packed more densely with a higher fill factor.

The stepped mirror unit can be multi-stage, in particular two-stage or three-stage. The stepped mirror unit can therefore comprise several stepped mirrors that are constructed in cascade. Outgoing partial beams of a first-stage stepped mirror, e.g. a first stepped mirror, fall onto a next-stage stepped mirror, e.g. a second stepped mirror, wherein further preferably outgoing partial beams of the second-stage stepped mirror, e.g. a second stepped mirror, fall onto a next-stage stepped mirror, e.g. a third stepped mirror. The stepped mirrors of different stages thus form a cascade. Each stepped mirror is arranged in such a way that adjacent mirrors are offset from each other in the first direction by a stepped distance.

The stepped height of each stepped mirror is preferably smaller than its stepped distance. The ratio of stepped height to the stepped distance can be between 0.2 and 0.4. Preferably, the stepped distance of a stepped mirror can correspond to the stepped height of the preceding stepped mirror, i.e. the stepped mirror of the preceding stage. In particular, the stepped height and the stepped distance is constant for each stepped mirror.

Advantageously, the stepped mirror unit comprises a second stepped mirror with mirrors, a stepped distance between adjacent mirrors and a stepped height. The stepped distance of the second stepped mirror preferably corresponds to the stepped height of the first stepped mirror. This means that the partial beams of the array hit the first stepped mirror and then the second stepped mirror. The distance between the partial beams in the first direction, i.e. the row distance, is thereby reduced. The row distance between adjacent partial beams after reflection at the first stepped mirror corresponds to the stepped height of the first stepped mirror. The stepped distance of the second stepped mirror corresponds to the stepped height of the first stepped mirror, so that the partial beams can fall onto the corresponding mirrors of the second stepped mirror. After passing through the second stepped mirror, the adjacent partial beams have a row distance that corresponds to the stepped height of the second stepped mirror.

The device can also comprise a third stepped mirror, wherein the third stepped mirror also has mirrors, a stepped distance between adjacent mirrors and a stepped height. The stepped distance of the third stepped mirror now preferably corresponds to the stepped height of the second stepped mirror.

Overall, the row distance is reduced by means of the stepped mirror unit, while the distance in the rows is not changed. After passing through a multi-stage stepped mirror unit, the row distance of adjacent partial beams is preferably reduced further and further in each stage.

The stepped height of the mirrors of the first stepped mirror preferably runs in the same absolute direction as the stepped height of the third stepped mirror. The stepped distance of the mirrors of the stepped mirrors of the first stepped mirror runs in particular in the same absolute direction as the stepped distance of the third stepped mirror. In particular, the stepped height of the second stepped mirror runs in the same direction as the stepped distance of the first and third stepped mirrors, while the stepped distance of the second stepped mirror can run in the same direction as the stepped height of the first and third stepped mirrors.

The stepped heights of different stepped mirrors of the same stage preferably run in the same absolute direction. In particular, the stepped distance of different stepped mirrors of the same stage run in the same absolute direction.

Preferably, the stepped mirror unit can have several, preferably two, stepped mirrors per stage. In such a case, one stepped mirror per stage forms a cascade of stepped mirrors. If the stepped mirror unit has, for example, two first, two second and two third stepped mirrors, these form two cascades of stepped mirrors. One part, e.g. half, of the partial beams can pass through a first such cascade and the other part, e.g. half, of the partial beams can pass through a second cascade. For example, half of the partial beams formed can each be coupled to one of the two sides of the stepped mirror unit.

In particular, the stepped mirror unit can consist of one or more, e.g. three, components. Each component can be formed monolithic. Each component can be wedge-shaped, wherein at least one stepped mirror can be arranged on one side surface. The mirrors of a stepped mirror are preferably formed as surfaces of a component and therefore do not have to be adjusted individually.

For example, the stepped mirror unit may have a wedge-shaped first component which may comprise a first and a third stepped mirror. Most preferably, the first component comprises both a first and a third stepped mirror on a first side surface. Furthermore, the component may also have a first and a third stepped mirror on a second side surface. The at least one third stepped mirror can be arranged in the tapered end region of the wedge-shaped first component.

Furthermore, the stepped mirror unit can comprise a second component, which preferably comprises a second stepped mirror on a first side surface. The first side surface of the second component faces in particular the first side surface of the first component.

In addition, the stepped mirror unit can have a third component, which also preferably comprises a second stepped mirror on a first side surface. The first side surface of the third component faces in particular the second side surface of the first component. In particular, the stepped mirror unit is mirror-symmetrical, preferably about a center line of the first component.

Furthermore, the second component and/or the third component is aligned with the first component in such a way that partial beams fall on the second stepped mirror after reflection from the first stepped mirror and fall on the third stepped mirror after reflection from the second stepped mirror. The mirrors of the first stepped mirror, the second stepped mirror and the third stepped mirror are preferably aligned parallel to each other.

The device can also comprise a coupling unit for coupling the partial beams behind the at least one acousto-optic deflector into the stepped mirror unit. The coupling unit is used for precise adjustment of the partial beams in the direction of the stepped mirror unit.

The coupling unit can be formed as a stepped mirror with mirrors, a stepped distance between adjacent mirrors and a stepped height. Adjacent mirrors are again arranged in the first direction of the array. The stepped height of the coupling unit preferably corresponds to the stepped distance of the first stepped mirror. A first reduction of the distance between adjacent partial beams in the first direction therefore already takes place in the coupling unit. Also in the coupling unit, the stepped height is in particular formed smaller than the stepped distance of the coupling unit. The mirrors of the coupling unit are preferably formed as separate mirrors that can be adjusted individually. In particular, this allows precise adjustment of the individual partial beams in relation to each other or to the following stepped mirrors.

The coupling unit can be formed as an upstream stage of the stepped mirror unit. This can result in a four-stage cascade of stepped mirrors. The coupling unit can be integrated into the stepped mirror unit. For example, the coupling unit can be arranged on a component of the stepped mirror unit and thus be monolithically formed with at least one stepped mirror of the stepped mirror unit.

The stepped distance of the coupling unit can be between 10 mm and 40 mm, preferably between 20 mm and 30 mm, most preferably between 23 mm and 27 mm, or 25 mm. The stepped height is preferably between 6 mm and 10 mm, preferably between 7 mm and 9 mm, or 8 mm.

Preferably, the device has at least one Fourier lens. With the aid of the Fourier lenses, the discrete diffraction angles of the at least one acousto-optic deflector can be converted into preferably equidistant foci in a first intermediate image plane. This can result in a telecentric arrangement on the image side. The object-side focal plane of the Fourier lenses can lie in the plane of the acousto-optic deflectors. The foci then lie in the focal plane of the Fourier lenses on the image side, and the propagation directions of the partial beams are parallel to each other. In particular, the device has one Fourier lens per row of the array and/or per acousto-optic deflector. The Fourier lenses are arranged between the at least one acousto-optic deflector and the stepped mirror unit.

Wedge plates, for example Risley prisms, and/or plane-parallel plates that can be tilted can be provided for adjusting the partial beams. Alternatively, laterally displaceable, especially long focal length lenses can be provided, wherein the focal length ratio of these lenses to the Fourier lenses determines the transmission ratio of the resulting displacement of the partial beams. The ratio of the focal length of the lenses to that of the Fourier lenses is preferably greater than 5, most preferably greater than ten.

Preferably, the stepped distance of the first stepped mirror is between 4 mm and 12 mm, preferably between 6 mm and 10 mm or between 7 mm and 9 mm. Further preferably, the stepped distance can be between 7.5 mm and 8.5 mm, most preferably 8 mm. The stepped height of the first stepped mirror is in particular between 0.5 mm and 3.5 mm, preferably between 1 mm and 3 mm, more preferably between 1.5 mm and 2.5 mm, most preferably 2 mm.

The stepped distance of the second stepped mirror is in particular between 0.5 mm and 3.5 mm, preferably between 1 mm and 3 mm, more preferably between 1.5 mm and 2.5 mm, most preferably 2 mm. The stepped height of the second stepped mirror is preferably between 0.25 mm and 0.75 mm, more preferably between 0.4 mm and 0.6 mm, most preferably between 0.45 mm and 0.55 mm. Furthermore, the stepped height can be 0.5 mm.

The stepped distance of the third stepped mirror is preferably between 0.25 mm and 0.75 mm, further preferably between 0.4 mm and 0.6 mm, most preferably between 0.45 mm and 0.55 mm. Furthermore, the stepped distance can be 0.5 mm. The stepped height of the third stepped mirror is preferably between 0.1 mm and 0.3 mm, more preferably between 0.15 mm and 0.2 mm, most preferably between 0.16 mm and 0.19 mm. Furthermore, the stepped height can be 0.1875 mm.

Preferably, the device comprises a beam splitter unit for splitting the laser beam in the first direction, preferably into a column of partial beams, in other words, the laser beam is split into several partial beams in the first direction. This means that the beam splitter unit has in particular one input and several outputs in the first direction. The beam splitter unit can comprise several beam splitters. Furthermore, the beam splitter unit can be formed as an acousto-optic deflector.

The device can comprise a separate acousto-optic deflector for each row of the array to be formed. In particular, the device comprises a separate acousto-optic deflector for each partial beam leaving the beam splitter unit for splitting the respective partial beam in a second direction and thus for generating several rows and thus the array of partial beams. The distance of the acousto-optic deflectors preferably corresponds to the distance of the partial beams after the beam splitter unit. Each acousto-optic deflector is formed in particular as a single-axis acousto-optic deflector with a single input and a plurality of outputs. The distance of the outputs corresponds to the distance of the partial beams in the second direction after the Fourier lenses.

While the beam splitter unit thus generates a plurality of partial beams in the first direction, the acousto-optic deflectors each generate a row, resulting in an array overall. In particular, the stepped distance of the coupling unit corresponds to the distance of the acousto-optic deflectors.

Due to the structural distance of the acousto-optic deflectors, the row distance is significantly greater than the distance within a row. This significantly limits the fill factor. Although the distance of the partial beams in the first direction initially corresponds to the distance of the acousto-optic deflectors, this is reduced by the stepped mirror unit and preferably the coupling unit in the first direction. In particular, the row distance of the partial beams of the array after the stepped mirror unit corresponds to the distance of partial beams within the rows. In other words, the row distance of the partial beams is adjusted to the distance of adjacent partial beams within a row by means of the stepped mirror unit and, if necessary, the coupling unit. The stepped mirror unit, if applicable together with the coupling unit, is formed to reduce the row distance, preferably by around two orders of magnitude. While the row distance after the acousto-optic deflectors is approximately a few centimeters, it is approximately 200 micrometers after passing through the stepped mirror unit.

Further preferably, the device may comprise relay optics, which preferably has a microscope objective. The microscope objective may have a focal length between 5 mm and 50 mm, preferably between 30 mm and 35 mm, preferably 33 mm. Furthermore, the microscope objective may have a numerical aperture between 0.1 and 1.0, preferably between 0.4 and 0.6.

The relay optics is used to reduce the row distance and the distance between adjacent partial beams within a row. With the help of the relay optics, the dimensions of the entire array are reduced after passing through the stepped mirror unit. The distance in the first direction and the distance in the second direction are reduced equally. The fill factor therefore does not change here.

In particular, the relay optics is formed with two stages, wherein both stages can have the same imaging ratio. Furthermore, the relay optics can have more than two stages. The relay optics preferably comprises two collimators, which are arranged in front of the microscope objective, and at least one lens arranged between the collimators, in particular a focus lens, in the focal plane of which a further, preferably telecentric second intermediate image can be formed. Furthermore, a focusing group of lenses can be arranged between the collimators. The first and/or the second collimator can have a focal length preferably between 200 mm and 300 mm.

The two-stage design reduces the size of the relay optics and thus that of the entire device. In particular, the focusing group is arranged in the middle between the collimators. Furthermore, the relay optics can be telecentric on both sides.

The relay optics can consist of the two collimators, the focusing group and the microscope objective. A group is preferably understood to mean more than two lenses.

The relay optics is formed above all to show the size of the array after the stepped mirror unit as reduced by a factor of at least 20, preferably at least 30, most preferably at least 50. After passing through the relay optics, the array comprises a row distance and/or distance of adjacent partial beams within a row between 1 μm and 5 μm, preferably between 2 μm and 4 μm, most preferably in about 3 μm.

After the relay optics, the partial beams form optical tweezers. An optical tweezer is designed to fix a single atom at its position. In particular, the device is used to fix atoms for a quantum computer. In particular, the atoms are Rydberg atoms. This means that the atoms are excited. In detail, at least one electron of the electron shell is in a high state, namely in a so-called Rydberg state. An atom can be captured at the beam waist, i.e. the narrowest point of a partial beam after the relay optics.

Furthermore, the device may a unit for coupling radiation to excite atoms captured by the optical tweezers and/or for decoupling radiation originating from atoms captured by the optical tweezers. The unit is formed for coupling and/or decoupling in a pupil plane of the relay optics. The relay optics can have two pupil planes, namely a first and a second pupil plane. Coupling and decoupling in one pupil plane is particularly preferable, as this is where the beam waists of the partial beams are located and these are superimposed, so that the total diameter of all partial beams is minimal. This means that there is no astigmatism due to the tilted mirrors. The two pupil planes are located primarily between the first and second collimators, and one pupil plane is preferably located in the focal plane of the second collimator of the relay optics.

The device can be configured to shift the position of individual atoms. In particular, the atoms can be moved during gate operations of a deep quantum computing algorithm. The movement of the atoms allows the connectivity—typically a next-neighbor connectivity in Rydberg systems—to be changed dynamically. For example, direct entanglement between atoms that are originally or later in the algorithm far apart from each other can be generated by moving them. This enables the realization of a qubit register with dynamic connectivity beyond nearest neighbors.

The use of acousto-optic deflectors is particularly advantageous as they have the shortest possible response time and are therefore configured to shift the partial beams and thus the positions of the optical tweezers in microseconds. A shift is achieved by changing a high-frequency signal with which the respective acousto-optic deflector is controlled. This shifts the position of the optical tweezers, preferably in proportion to the frequency shift. A change in the high frequency is thus translated directly into a change in the position of the optical tweezers.

The fact that each row can be assigned its own acousto-optic deflector, exactly one deflector, means that the positions of trapped atoms within the individual rows can be changed independently of each other. In particular, the distance in each row can be changed to a microsecond scale. Shift operations of trapped atoms are thus minimally correlated. The fastest possible and highly parallel position shifting can be achieved, which is particularly advantageous as a corresponding rearrangement in a quantum computer involves a large number of optical tweezers. The device thus serves as a central building block for a quantum computer.

Furthermore, the device is configured to change the amplitudes of the individual tweezers of one row independently of those of other rows, as each row of the array is assigned its own acousto-optic deflector. This is achieved by adjusting the amplitude of the high-frequency signal. Overall, the positions and amplitudes of the optical tweezers can therefore be adjusted dynamically and with microsecond accuracy.

Furthermore, the invention may relate to a quantum computer comprising a device as described above.

In a further aspect, the present invention relates to a method for generating optical tweezers, preferably for trapping atoms for a quantum computer, the method comprising generating a laser beam by means of a laser beam source.

Further, the method comprises generating an array of partial beams by means of at least one acousto-optic deflector and reducing a row distance of the partial beams of the array by means of a stepped mirror unit comprising at least a first stepped mirror, wherein the first stepped mirror comprises mirrors, a distance between adjacent mirrors and a stepped height. In particular, the method comprises splitting the laser beam into partial beams in the first direction by means of a beam splitter unit and respectively splitting each partial beam into a row and thus generating the array of partial beams by means of a respective acousto-optic deflector.

The method may further comprise coupling the partial beams of the array into the stepped mirror unit, preferably by means of a coupling unit. Furthermore, the method may comprise passing through the stepped mirror unit, namely reflection at the first stepped mirror and preferably at the second stepped mirror and furthermore preferably at the third stepped mirror. The distance between the partial beams in the first direction is reduced both at the coupling unit and at each stepped mirror of the stepped mirror unit. Furthermore, the method can comprise a further reduction of the distance of the partial beams both in the first direction and in the second direction, preferably by means of relay optics, which can comprise a microscope objective.

In particular, the method is to be carried out by means of the above-mentioned device and the device is designed to carry out the method.

### BRIEF DESCRIPTION OF THE FIGURES

The figures show in a purely schematic representation:

FIG. 1: a device for generating optical tweezers;

FIG. 2: an array of partial beams,

FIG. 3: a detailed view of the device of FIG. 1, and

FIG. 4: an enlarged view of the stepped mirror unit of FIG. 3; and

FIG. 5: a process diagram of a method for generating optical tweezers.

### PREFERRED EMBODIMENTS

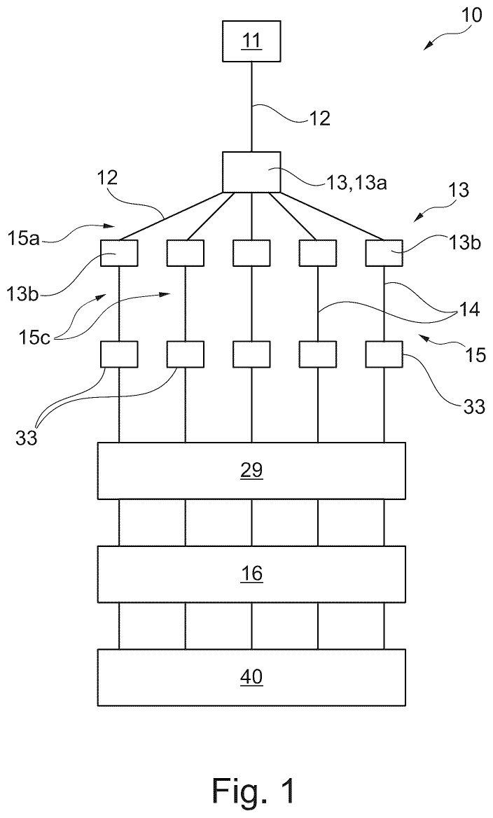

FIG. 1 shows a schematic representation of a device 10 for generating optical tweezers. The device 10 comprises a laser beam source 11 which couples out a laser beam 12. Furthermore, the device 10 comprises several acousto-optic deflectors 13, a beam splitter unit 13a, which splits the laser beam 12 into a plurality of partial beams 14, in this example a column 15a, and a plurality of acousto-optic deflectors 13b for splitting the partial beams 14 into rows 15c. The rows 15c run in the image plane so that the individual partial beams cannot be seen in FIG. 1. The result is an array 15 of partial beams 14.

Fourier lenses 33 are also shown schematically. Each row of the array 15 is assigned its own Fourier lens 33. Furthermore, a coupling unit 29 is shown, after which the partial beams 14 of the array 15 pass through the stepped mirror unit 16. This is followed by a relay optics 40, after which the partial beams 14 form optical tweezers.

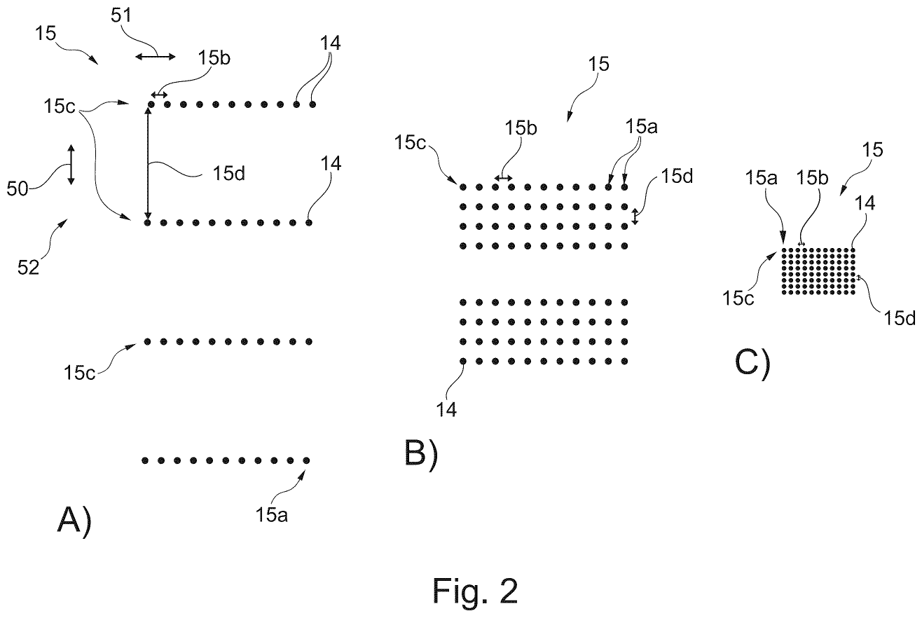

FIG. 2 shows the array 15 of partial beams 14 in the first direction 50 and the second direction 51. The third direction 52, in which the partial beams propagate, extends into the image plane. In the example of FIG. 2, the partial beams 14 are arranged in columns 15a with a distance 15b between partial beams in a row and rows 15c with a row distance 15d.

Section 2A shows how the row distance 15d is significantly greater than the distance 15b of partial beams in a row. This is due in particular to the size of the acousto-optic deflectors 13b. As shown in section 2A, the array 15 is present after the Fourier lenses, especially in the focal plane of the Fourier lenses, if no stepped mirror unit is used.

In section 2B, the array 15 is present after passing through the stepped mirror unit 16. More precisely, the array is present in the focal plane of the Fourier lenses when the stepped mirror unit 16 is used. The row distance 15d is significantly reduced. It now corresponds to the distance 15b of adjacent partial beams in a row.

In section 2C of FIG. 2, the distance 15d of the partial beams in a row and the row distance 15d after passing through the relay optics 40 is reduced again, preferably by a factor of 50 compared to section 2B.

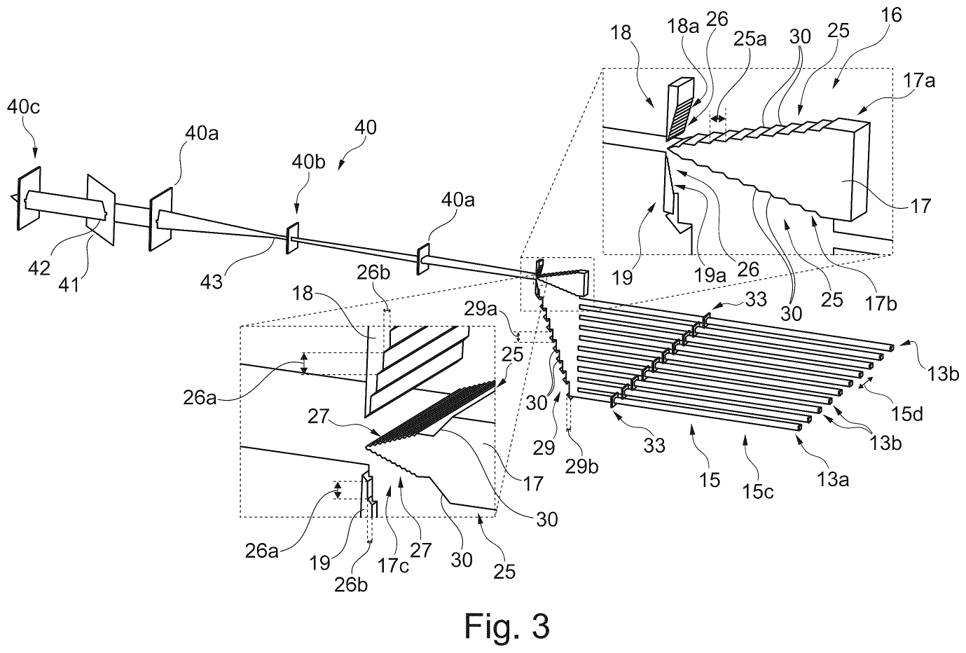

FIG. 3 shows a more detailed view of the device 10 in FIG. 1. While the beam splitter unit is not visible, the acousto-optic deflectors 13b and the Fourier lenses 33 can be seen. A Fourier lens 33 is assigned to each row of the array 15. At the position of the Fourier lenses 33, the first direction 50 of the array in FIG. 3 runs horizontally, while the second direction 51 runs vertically. The beams shown in FIG. 3 after the acousto-optic deflectors 13 are columns 15a of the array 15. Thus the row distance 15d can be seen. The distance 15b of partial beams in a row is so much smaller in comparison that it cannot be seen in FIG. 3.

FIG. 3 shows only the ten lowest rows 15c of the array 15, which are coupled on one side of the stepped mirror unit 16. Further rows 15c of the array 15 are coupled on the other side of the stepped mirror unit 16, which is described in more detail below.

The partial beams 14 pass through the Fourier lenses 33 and then hit the coupling unit 29, which consists of several mirrors 30. The coupling unit 29 is characterized by a fixed stepped distance 29a and a fixed stepped height 29b. The mirrors 30 are thus each offset by a step height 29b and a step distance 29a.

The stepped mirror unit 16 is shown in greater detail in the upper right section of FIG. 3. As can be seen, the stepped mirror unit 16 consists of three components, namely a first component 17, a second component 18 and a third component 19, which are formed wedge-shaped. The end areas, in which they taper to a point, face each other. The first component 17 is formed mirror-symmetrically.

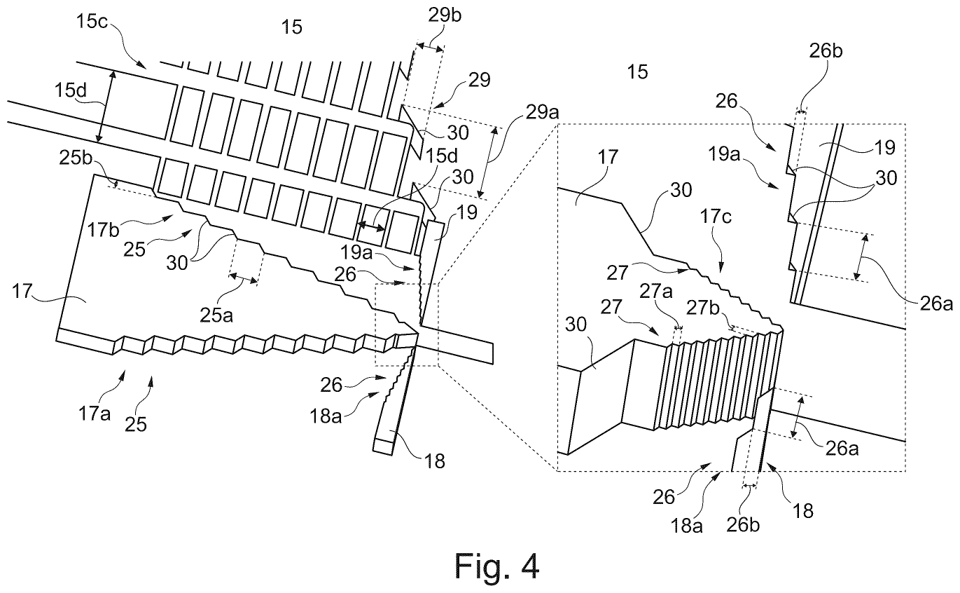

The first component 17 has a first side surface 17a and a second side surface 17b. A first stepped mirror 25 is arranged on each of the two aforementioned side surfaces with mirrors 30 and a stepped distance 25a between adjacent mirrors 30 and a stepped height 25b (see upper section of FIG. 3 and FIG. 4).

The second component 18 has a first side surface 18a, which is opposite the first side surface 17a of the first component 17. Furthermore, the third component 19 has a first side surface 19a, which is opposite the second side surface 17b of the first component 17. The first side surface 18a of the second component 18 and the first side surface 19a of the third component 19 each have a second stepped mirror 26 with a stepped distance 26a and a stepped height 26b between mirrors 30 (see also the lower section of FIG. 3 and FIG. 4).

Another even more detailed representation can be seen in the lower detailed representation of FIG. 3. The mirrors 30 of the second stepped mirrors 26 on the second component 18 and the third component 19 can be seen more clearly. It can also be seen how the first component 17 has a first end region 17c. In the first end region 17c of the first component 17, a third stepped mirror 27 is arranged on each of the two side surfaces of the first component 17 with a stepped distance 27a and a stepped height 27b.

The relay optics 40, which consists of two collimators 40a and a focusing lens group 40b arranged between them, follows the stepped mirror unit 16. Furthermore, the relay optics 40 comprises a microscope objective 40c. A decoupling mirror 41 is arranged between the second collimator 40a and the microscope objective 40c. The decoupling mirror 41 lies in a pupil plane 42, which is optimally suited for coupling radiation to excite trapped atoms or for decoupling radiation from trapped atoms. A second intermediate image plane 43 can be arranged after the lens group 40b.

The row distance 15d of the partial beams was initially reduced by means of the stepped mirror unit 16 and the coupling unit 29. A further reduction of both the row distance 15d and also the distance 15b of partial beams in a row then takes place via the relay optics 40 by means of the microscope objective 40c, among other things.

FIG. 4 shows an enlarged view of the stepped mirror unit 16 from FIG. 3. The first component 17 with first stepped mirrors 25 arranged on both sides can be clearly seen on the respective side surfaces 17a, 17b. Furthermore, three mirrors 30 of the coupling unit 29 can be seen. Their stepped distance 29a and their stepped height 29b can be clearly seen.

Due to the offset arrangement of the mirrors 30 of the coupling unit 29, these represent a stepped mirror. Furthermore, the second component 18 and the third component 19 of the stepped mirror unit 16 can be seen, which have a second stepped mirror 26 on the respective first side surfaces 18a, 19a. In the enlarged representation on the right-hand side of FIG. 4, the first end region 17c of the first component 17 can be clearly seen in particular. A third stepped mirror 27 with the stepped distance 27a and the stepped height 27b is arranged on each of the side surfaces 17a and 17b.

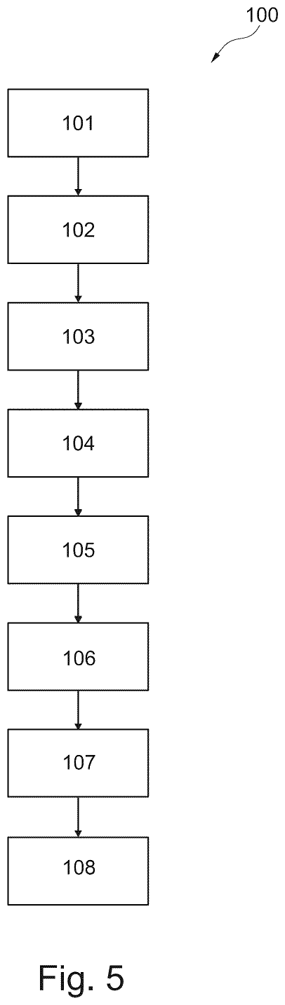

FIG. 5 shows a method diagram of a method 100 for generating optical tweezers, comprising generating 103 an array 15 of partial beams 14 and reducing 106 a row distance 15d of the array, in other words the distance of the partial beams of the array 15 in at least a first direction 50.

First, the method 100 can comprise splitting 101 the laser beam 12 of a laser beam source 11 into partial beams 14 in a first direction and then splitting 102 the partial beams thus generated in a second direction 51 and thus into rows 15c. In this way, the array 15 is generated 103.

Subsequently, the partial beams 14 of the array 15 can be coupled 104 into the stepped mirror unit 16 and pass through 105 the stepped mirror unit 16. In this way, the row distance 15d of the partial beams 14 is reduced 106. A further reduction 108 of the distance of the partial beams 14 of the array 15 in both directions is achieved in particular by passing 107 through a relay optics 40.

### REFERENCE NUMBERS

10 device
11 laser beam source
12 laser beam
13 acousto-optic deflector
13a beam splitter unit
13b acousto-optic deflector
14 partial beams
15 array
15a column
15b distance within a row
15c row
15d row distance
16 stepped mirror unit
17 first component
17a first side surface of the first component
17 second side surface of the first component
17c first end portion of the first component
18 second component
18a first side surface of the second component
19 third component
19 first side surface of the third component
25 first stepped mirror
25a stepped distance of the first stepped mirror
25b stepped height of the first stepped mirror
26 second stepped mirror
26a stepped distance of the second stepped mirror
26b stepped height of the second stepped mirror
27 third stepped mirror
27a stepped distance of the third stepped mirror
27b stepped height of the third stepped mirror
29 coupling unit
29a stepped distance of the coupling unit
29b stepped height of the coupling unit
30 mirror
33 Fourier lenses
40 relay optics
40a collimator
40b focusing lens group
40c microscope objective
41 decoupling mirror
42 pupil level
43 second intermediate image plane
50 first direction
51 second direction
52 third direction
100 method for generating optical tweezers
101 splitting the laser beam into partial beams in a column
102 splitting the partial beams into rows
103 generating an array of partial beams
104 coupling the partial beams of the array into the stepped mirror unit
105 passing through the stepped mirror unit
106 reduction of a row distance of the partial beams of the array
107 passing through the relay optics
108 reduction of the row distance and distance of the partial beams in a row

1. Device for generating optical tweezers,
wherein
a laser beam source for generating a laser beam, and
at least one acousto-optic deflector for generating an array of partial beams of the laser beam,
wherein the array comprises rows,
wherein
the device has a stepped mirror unit comprising at least one first stepped mirror for reducing a row distance of the partial beams of the array,
wherein the first stepped mirror comprises mirrors, a stepped distance between adjacent mirrors and a stepped height.

2. Device according to claim 1,
wherein
the stepped mirror unit is multi-stage, preferably two- or three-stage.

3. Device according to claim 1,
wherein
the stepped mirror unit comprises a second stepped mirror,
wherein the second stepped mirror comprises mirrors, a stepped distance between adjacent mirrors and a stepped height,
wherein the stepped distance of the second stepped mirror corresponds to the stepped height of the first stepped mirror.

4. Device (10) according to claim 3,
wherein
the stepped mirror unit comprises a third stepped mirror,
wherein the third stepped mirror comprises mirrors, a stepped distance between adjacent mirrors and a stepped height,
wherein the stepped distance of the third stepped mirror corresponds to the stepped height of the second stepped mirror.

5. Device (10) according to claim 1,
wherein
the device comprises a coupling unit for coupling the partial beams into the stepped mirror unit,
wherein the coupling unit comprises mirrors, a stepped distance between adjacent mirrors and a stepped height,
wherein the stepped height of the coupling unit corresponds to the stepped distance of the first stepped mirror.

6. Device according to claim 1,
wherein
the stepped height of the first stepped mirror is smaller than the stepped distance of the first stepped mirror and/or
the stepped height of the second stepped mirror is smaller than the stepped distance of the second stepped mirror and/or
the stepped height of the third stepped mirror is smaller than the stepped distance of the third stepped mirror, and/or
the stepped height of the coupling unit is smaller than the stepped distance of the coupling unit.

7. Device according to claim 1,
wherein
the stepped distance of the first stepped mirror is between 4 mm and 12 mm, preferably between 6 mm and 10 mm, most preferably between 7 mm and 9 mm, and/or
the stepped height of the first stepped mirror is between 0.5 mm and 3.5 mm, preferably between 1 mm and 3 mm.

8. Device according to claim 3,
wherein
the stepped distance of the second stepped mirror is between 0.5 mm and 3.5 mm, preferably between 1 mm and 3 mm, and/or
the stepped height of the second stepped mirror is between 0.25 mm and 0.75 mm, preferably between 0.4 mm and 0.6 mm.

9. Device according to claim 4,
wherein
the stepped distance of the third stepped mirror is between 0.25 mm and 0.75 mm, preferably between 0.4 mm and 0.6 mm,
and/or the stepped height of the third stepped mirror is between 0.10 mm and 0.30 mm, preferably between 0.150 mm and 0.20 mm.

10. Device according to claim 1,
wherein
the device comprises a beam splitter unit for splitting the laser beam into partial beams in a first direction,
wherein the device comprises one acousto-optic deflector per partial beam for dividing the partial beams into rows and thus for generating the array of partial beams.

11. Device according to claim 1,
wherein
the device comprises relay optics comprising a microscope objective for reducing the row distance and the distance of partial beams within a row, wherein the partial beams after the relay optics form optical tweezers for capturing atoms.

12. Device according to claim 1,
wherein
the device has a unit for coupling radiation to excite atoms captured by means of the optical tweezers and/or for decoupling radiation originating from atoms captured by means of the optical tweezers,
wherein the unit is configured for coupling and/or decoupling in a pupil plane of the relay optics.

13. Method for generating optical tweezers,
wherein the method comprises generating an array of partial beams by means of at least one acousto-optic deflector,
wherein the array comprises rows,
wherein
the method comprises a reduction of a row distance of the partial beams of the array by means of a stepped mirror unit having at least a first stepped mirror,
wherein the first stepped mirror comprises mirrors, a stepped distance between adjacent mirrors and a stepped height.
